(19) United States
(12) Patent Application Publication
(10) Pub. No.: US 2015/0038178 A1
(43) Pub. Date: Feb. 5, 2015

(54) COMMUNICATION SYSTEM

(71) Applicant: C & L Ventures Pty Ltd,, Toorak, Victoria (AU)

(72) Inventors: Yit Fun Chin, Toorak (AU); Hean Leng Tai, Toorak (AU)

(21) Appl. No.: 14/378,133

(22) PCT Filed: Nov. 20, 2012
(86) PCT No.: PCT/AU2012/001438

§ 371 Date: Aug. 12, 2014

(30) Foreign Application Priority Data
Apr. 30, 2012 (AU) 2012901688

(51) Int. Cl. H04W 4/04; H04W 8/00

(52) U.S. Cl. CPC H04W 4/043; H04W 8/005
USPC 455/457

(57) ABSTRACT

Disclosed herein is a system for communication between users in a venue. The system comprises: detecting a first communication device recognisable by a primary communication device in a venue, the primary communication device capable of transferring details of the venue, the first communication device being capable of receiving details of the venue; transferring the details of the venue from the primary communication device to the first communication device; and displaying the details of the venue on the first communication device and illustrating location based information of one or more second communication devices being first communication devices of other users.

### TECHNICAL FIELD

The invention relates to a system for communication between users in a venue,

### BACKGROUND TO THE INVENTION

Meeting and greeting people can be a difficult task given the hesitation in some to make the first approach to a new person. Individuals often lack the confidence to initiate the first contact to a stranger and can feel embarrassed to do so. Individuals can have a fear of rejection or merely have the lack of confidence or lack of desire to be put into such an uncomfortable situation. This can raise considerable emotional stress, particularly for the younger generation.

Venues such as cafes provide a location for casual communication and interaction and many cafes further provide features or resources for communal internet access. For group gaming or communication, it can be difficult to approach a stranger in the same venue and request common participation in a game or communication given the physical interaction that needs to be made.

A further difficulty with online gaming at a venue generally, outside of a common venue, is that befriending people online can have its dangers. This is because users often do not know the other online players and their first meeting is often online, on different computers in different places/countries. This allows some users to provide false accounts as to names and details and may gain trust of other players under false pretences with dangerous intentions.

It would be advantageous to provide a process for communication between individuals that did not require initiation by face-to-face contact.

The discussion of the prior art above is included in this specification solely for providing a context for the present invention. It is not suggested or represented that any or all of these matters form part of the prior art base or were common general knowledge in the field relevant to the present invention as it existed in Australia or elsewhere before the priority date of each claim of this application.

### SUMMARY OF THE INVENTION

The present invention provides a way for users to communicate at a venue. In one aspect, the invention provides a system for communication comprising:
a) detecting a first communication device of a first user recognisable by a primary communication device in a venue, the primary communication device capable of transferring details of the venue, the first communication device being capable of receiving details of the venue;
b) transferring the details of the venue from the primary communication device to the first communication device; and
c) displaying the details of the venue on the first communication device and location based information of one or more second communication devices being communication devices of other users.

In one form, the invention allows for profile information from the primary communication device to also be transferred to the first communication device.

In one form, the first communication device and second communication device are a mobile phone.

In one form, the primary communication device allows the first communication device to communicate with one or more of the second communication devices. This allows a single individual to communicate with multiple communication devices. The communication can be on a selectable basis.

In one form, the primary communication device can be a server. In one form, the primary communication device is located within the boundaries of the venue, referred to below as the venue zone. The primary communication device can be accessed by the first mobile communication device within the venue zone or can be accessed by the first mobile communication device outside the venue zone. An advantage here is that the primary communication device can be accessed by the first communication device inside or outside the venue zone. Therefore, in one form, the primary communication device can be accessed outside the venue zone to download the communication system and/or obtain the floor plan of the venue. In such a form however, it is preferred that the user is to be within the venue zone to communicate with the one or more second communication devices of other users.

It is to be understood that the term “venue” or “venue zone”, as used herein, is used to refer to any public and private venue including, but not limited to, restaurants, cafes, lecture/seminar rooms, conventions, conferences, seminars, sports stadiums and the like for such purposes as social interaction, control of large masses of people and emergency evacuations. However, for convenience sake, the invention will be described as being applied to a cafe.

In a further form, the details of the venue comprise a floor plan of the venue. In another form, the location based information is a user's location to identify the user's position on a floor plan. The user's location ID can be identified as a marker on the floor plan, allowing other users to view on the floor plan the position of the marker of a number of other users. The location based information can be allocated to the user, entered by the user and/or detected about the user. If allocated to the user, in one form, the user is provided with a ticket illustrating a reference/coordinates (such as a seat/table number) in which they are to position themselves and manually enter their location ID. If detected about the user, the communication system recognises the location based information of the first communication device of the user.

The location based information can be dynamically altered in real time. In this form, changes in the location based information of the user or components of the floor plan (Such as chairs and tables) are automatically shown on the floor plan. The location based information can further be checked indirectly or checked directly by use of comparison of the location based information of a signal to the user's first communication device and actual location. Such comparison can also extend to a comparison to the one or more second communication devices.

In one form, the first user and other users can create a user profile. In one form, the user profile is a basic profile comprising a first level of information comprising the user's name and username. In another form, the user profile is a personalised profile comprising comprehensive information about the user. In another form, the user profile includes both a basic profile and personalised profile.

In one form, a determinator automatically determines one or more profiles by input data entered by the user. To do so, the input data is assessed by the determinator according to a profile template to generate the profile. The user can pre-select what input data is presented by the determinator on the profile page.

The invention further provides for displaying the details of the venue on the first communication device and illustrating location based information of one or more second communication devices forms a ‘personalised’ floor plan of a first user, whereby the marking of other users occurs where the other users are in direct or current communication with the first user.

In a further aspect, the invention comprises of a system for communicating between users at a venue, the system comprising:
a first communication device recognisable by a primary communication device in a venue, the primary communication device capable of receiving and transferring the floor plan of the venue;
wherein, the primary communication device transfers to the first communication device a location system, which the floor plan indicates the position of the first communication device and a second communication device;
wherein the first communication device is in a visually locatable position to a second communication device.

In one form, the primary communication device is a server. In a further form, the primary communication device is a combination of a server and a router.

In one form, the first communication device and second communication device are a mobile phone.

In one form, the pre-defined location system is an interactive floor plan. This can be a virtual interactive floor plan.

In a further form, the pre-defined location system is selected from one or more of a mapping system, coding system and/or locating system.

In a further aspect, the invention provides for a process for communication, comprising the steps of:
a. connecting a first mobile communication device of a first user to a server;
a. transferring a floor plan of a venue from the server to the first mobile communication device;
b. marking a location of the first communication device on the floor plan; and
c. marking the location of a second communication device on the floor plan wherein, the first user can view the location of a second user of the second communication device to initiate communication

In one form, the server is located within the venue. In one form, the communication system provides a product that result from the above one or more processes. The product, in one form, is an interactive floor plan.

In yet another aspect, the invention provides a product resulting from the above one or more processes. The product comprises an interactive floor plan having:
a) a display of one or more rooms and the furnishings of such rooms;
b) at least two markers defining a first users and second users location on the floor plan relative to the rooms and the furnishings;
c) the marking operatively defining a communication means between the first user and a second user.

In one aspect, the invention further provides a system of communication comprising of:
a) providing an operational marker on a virtual floor plan to identify the location of a user;
b) determining the position of the user on a floor plan by viewing the marker on the floor plan; and
c) initiating contact by sending a request to the user by activating the operational marker to provide a means for communication.

Further to the above system, the user is able to accept or decline the request. A notification is sent accordingly. If declining the request, the notification can include a personalised message.

It can be seen that the invention provides a system and process for communication between users in a venue providing a means of communication between individuals in the same location without having to physically approach a user to also thereby allow a person to physically approach a user that is of particular interest and reciprocates interest.

The advantage of the invention is that the user can physically sight the second user in the venue before initiating contact.

### BRIEF DESCRIPTION OF THE FIGURES

FIG. 1 is a diagrammatic illustration of the interaction between the communication components of the invention and the hardware components of the invention, in accordance with one form of the invention;

FIG. 2 is a diagrammatic illustration of the line of communication and transfer of signals when a first user is using a first mobile communication device when communicating with a second user on a second mobile communication device, in accordance with one embodiment of the invention;

FIG. 3 is a flow chart illustrating the process in which communication is initiated, in accordance with one embodiment of the invention;

FIG. 4 is a diagrammatic illustration of the set up of a user's/venue's profile page, and other input data, in accordance with an embodiment of the invention;

FIG. 5 is a diagrammatic illustration of a floor plan with multiple categorically coloured markers, in accordance with one embodiment of the invention; and

FIG. 6 is a diagrammatic illustration of ‘a personalised’ floor plan of a first user, in accordance with another embodiment of the invention.

### DETAILED DESCRIPTION OF THE INVENTION

The invention provides a system for communication in some embodiments. The invention is operational on a communication and/or internet based system.

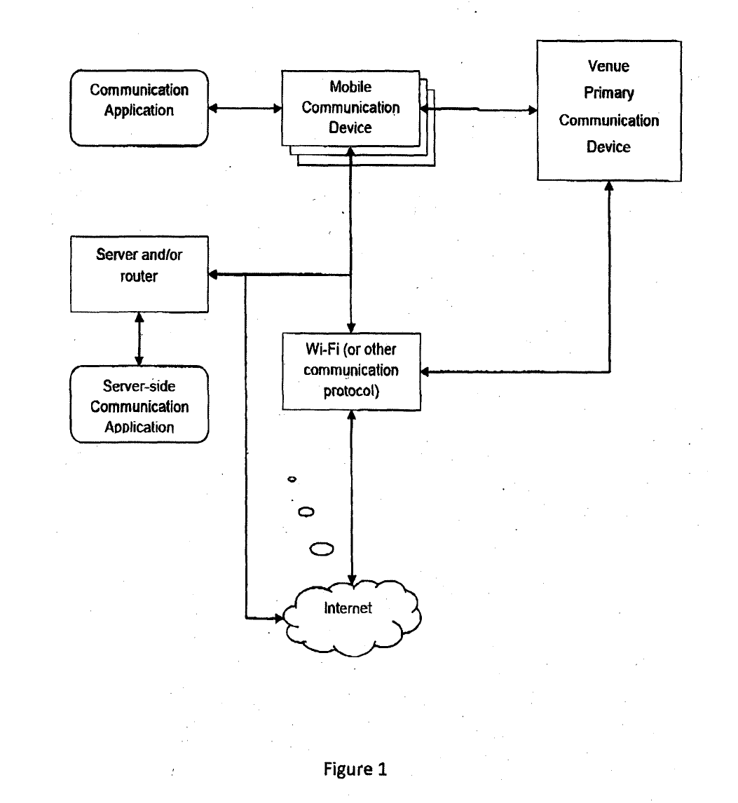

In a preferred embodiment, the invention operates as a communication system on a communication application and partly on an internet based system, as illustrated in FIG. 1. The communication system illustrated in FIG. 1 has two main communication components:
The communication application that runs on a mobile communication device, referred to herein as first and second communication devices, where the second communication devices are first communication devices of other users.
The communication application that runs on a primary communication device such as a server and/or router including supporting systems e.g. databases. The primary communication device is capable of recognising the mobile communication devices and transferring information such as a floor plan 21 of a venue.
   The communication can take place via a mobile network. The communication system requires one or more mobile communication devices on which the communication system operates, being the first communication device and the at least one second communication device. Such mobile communication devices include mobile phones, laptops, tablets and computers such as iPhone™, iPad™ and Android™ iOS and iPod Touch with base OS of 5.1.

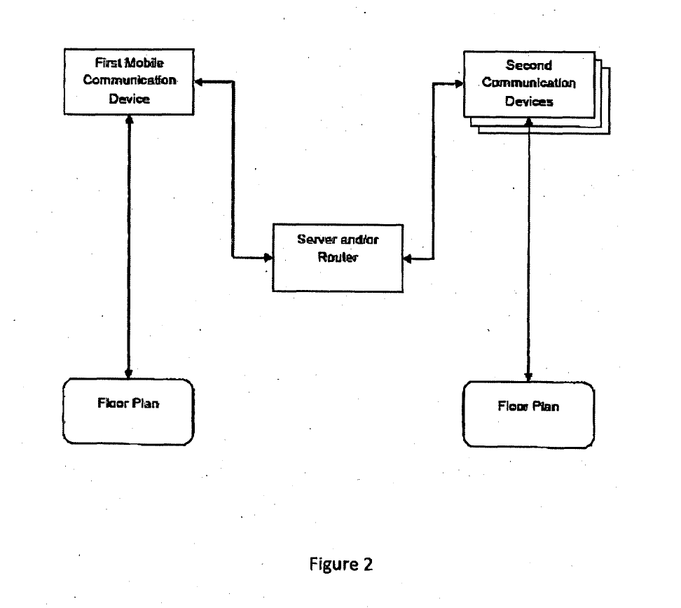

FIG. 2 illustrates the relationship between the floor plan, the server, the router, the first mobile communication device and the second mobile communication device. As shown in FIG. 2, a venue has the primary communication device, such as a server where the primary communication device provides a centralised resource or service in a network. The centralised resource or service can be contained primarily within the boundaries of the venue, referred to as the venue zone. However, the centralised resource or service can be defined by the operation boundaries of the router such that users outside the venue zone can access features of the communication system. The router can be accessed by a first user having a mobile communication device within the venue zone, the venue zone being the area recognised by the server.

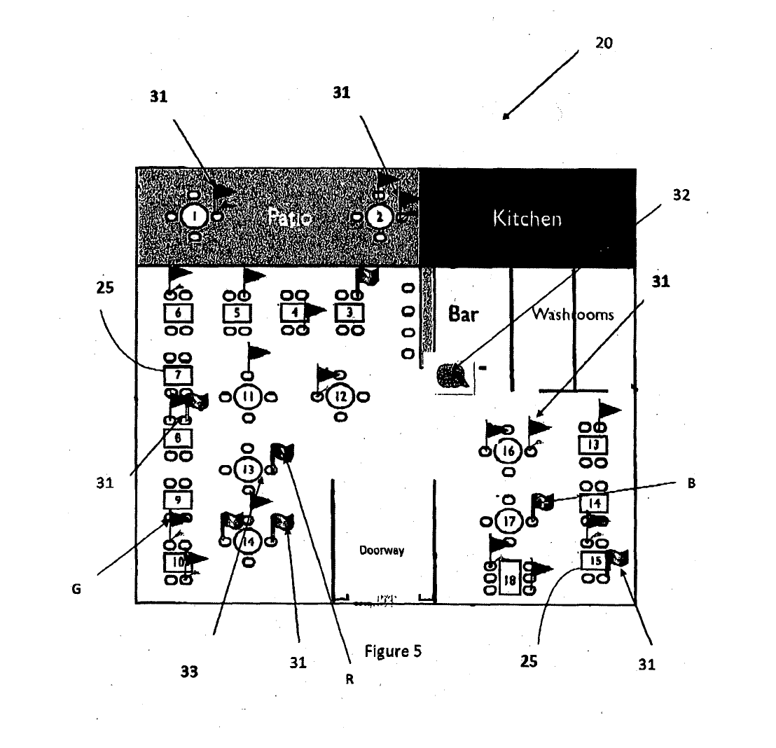

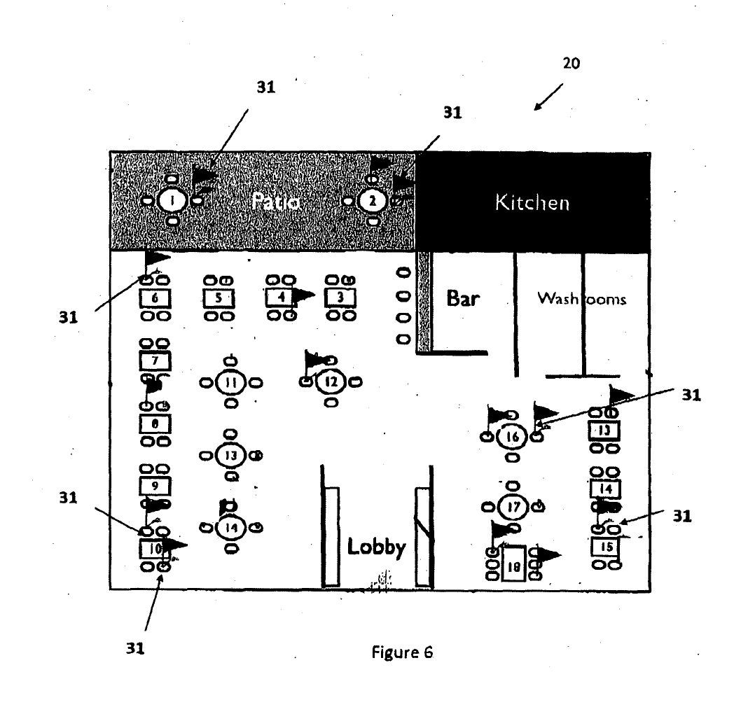

The floor plan 20 of the venue may be a scaled diagram of the arrangement of rooms, or arrangement of items in a room, as shown in FIGS. 5 and 6. The floor plan can be a single floor plan or multiple floor plans, particularly where the venue has more than one accessible room or floor, or where different floor plans are used for different times of the day to cater for different number of users. Further, the floor plan can be segmented such that only an area concerning the user is shown. The floor plan details location based information of items such as tables 25, chairs 33, emergency exits, washrooms, exits, VIP areas, gaming stations etc. In doing so, the user has an easy access to the floor plan and can readily identify position location information or determine their location based on the location based information of surrounding items.

If more than one floor plan 20 is used, the user can manually select the relevant floor plan or, alternatively, the floor plan is discretionally provided to the user by the server according to their determined location relative to the server at a particular time which wilt dictate which floor plan is made accessible to the user. This can be done by an automatic downloading option. However, in the preferred form, as the user enters the venue they are provided with a unique venue code. The venue code is then entered into the software with the location ID. The software then recognises which venues floor plan to download.

The floor plan is provided by the venue or automatically created after input data is entered and assessed by a determinator according to a predetermined floor plan template. The floor plan is therefore recreated every time it is downloaded but standardised according to a predetermined template. Upon entering the venue, a user having a mobile communication device that is connected to the server, such as via WiFi, will have the floor plan automatically downloaded onto their mobile communication device. The user is then able to use the connected mobile communication device to facilitate communication or gaming with other users in the venues with the same application.

The floor plan can be fixed, showing a floor plan that will need to be amended and reloaded in order to be current and accurate. In an alternate form, the floor plan can be in fluid form with recognition facilities of items in the venue such that changes in location of such items are automatically illustrated onto the floor plan.

The floor plan further illustrates one or more markers 31. A marker 31 denotes a seat or table or particular position location ID on the floor plan that is or can be occupied by an individual. In one embodiment, the floor plan and markers may be dynamic, constantly changing to reflect actuate real-time changes in the venue or users. This may require the user to access other forms of positioning technologies.

Each seat or table or position location ID in the venue has an identifier, such as a seat number or table number 25. When the user is seated, the user will enter the corresponding identifier into their connected mobile communication device which transfers the information to the server. The user's location is then marked on the floor plan as occupied and with further information as desired, such as username or information from the profile. The marker 31 can be a little flag or pin which will pop up on the floor plan. The markers 31 are viewable by all connected mobile communication devices such that users of such devices are aware that the location is occupied.

The seat and table numbers can be numbered graphically on the floor plan, as shown in FIGS. 5 and 6. This can identify to the user their location ID. Alternatively, the location ID is provided to the user as they walk into the venue by a venue employee. In an alternate form, the user is able to view their location on the floor plan and further drag and drop markers in their relevant location. Markers appearing on the floor thereby illustrate which seats/tables are occupied at a particular point in time. The user can zoom in and out of the floor plan. The floor plan can be rotated or allow the user to scroll or slide the floor plan in any direction.

The markings 31 allow the first user to determine where they are located relative to other users and relative to items in the venue. The markings therefore allow the user to determine where they are located relative to other users logged into the server and can visually sight (or assist to visually sight) such other users. Such users can include other patrons, emergency personnel, should an emergency situation arise, or wait staff.

The invention is therefore further advantageous for its application to other uses such as wait staff being able to use the markers to identify where the users are located, which tables are vacant and which are full. In an alternate embodiment, staff can input information onto the floor plan such as time or timers, colour coding to identify whether users are up to appetiser, mains or desserts.

In an embodiment where the floor plan is dynamic, further uses of the invention can include:
Emergency personnel can use the floor plan to determine where all users are located such that finding people in a fire situation is made easier.
Users can use the markers to identify the position of such emergency staff or floor staff and to communicate with wait staff for prompt service.

The markers can be colour coded. The markers can be a flag, pin, picture of the avatar or other symbol, initials etc. for each user whose application is running and location id is entered. In one example, the colour coding is as follows:
Green (“G”)—available for contact
Blue (“B”)—available for contact and engaged in other activities
Red (“R”)—unavailable for contact

The user can allow for selective display of the markers 31 to further provide an interactive floor plan and also a personalised floor plan. For example, the user can select that the floor plan illustrate only the markers in green, or only the markers of other users listed as friends. This allows the communication to filter the visibility of one or more flags representing the users in the venue zone.

Upon re-entering the facility, the user has the choice of re-downloading the floor plan form the server. Optionally, the user can save the floor plan onto their mobile communication device for further use as this will save download time for regular patrons/users. However, it is noted that downloading from the server directly ensures that the current floor plan is always in use. However, the stored floor plan can be recognisable by the server such that, when the user accesses and tries to use an outdated floor plan, a message or signal is sent via the server to the mobile communication device notifying the user that the floor plan is outdated and providing means to access, download and store the current floor plan.

The floor plan is an example of one predefined locator system. In an alternate form, the predefined locator system can be a coding system. An example of such a coding system is where the user in fact does not see the floor but receives the location ID of other users. For example, if tables in a venue are identified as A, B, C etc, the user can receive such location ID as C3, C5, C8. The user will recognise these three users as being seated at Table C and, knowing that Table C is in one corner of the venue, will be able to determine the physically positioning of the users.

In the preferred form, the invention is used as a means for initiating communication for gaming purposes between two users. In doing so, the system further allows for tracking and storing the length of games played, communication history and other activities for each user. It further also allows for the tracking and storing virtual credits for each user.

As an internet based system, a website is created for a venue comprising of multiple webpages. The invention further provides for a server and/or router which uses the internet platform in which to transfer data between the mobile communication device, the server and the webpages. The system is compatible with such major browsers as, but not limited to, Internet Explorer, Firefox, Chrome, Opera and Safari. However, it is recognised that the transfer of data can occur through other methods including Wi-Fi.

The webpage can be accessed within or outside the venue using a server or via standard internet access methods. This allows the first user to create and update a user profile conveniently outside the venue zone. This further allows the communication to be downloaded by the user inside or outside the venue zone however, to use the communication requires the user to be within the venue zone. The communication will only need to be downloaded once to operate. However, as the communication is updated, or the floor plan is updated, different versions can be further downloaded inside or outside the venue zone.

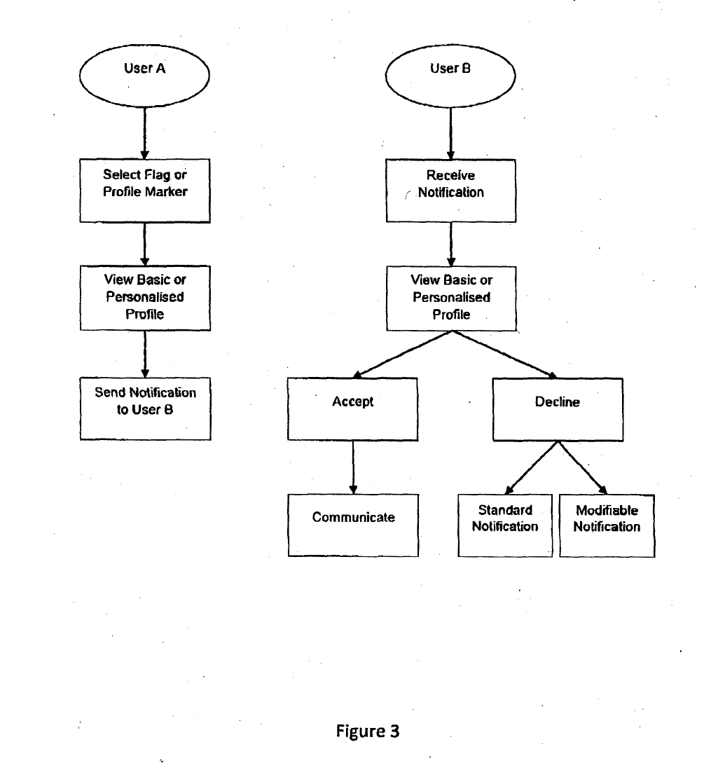

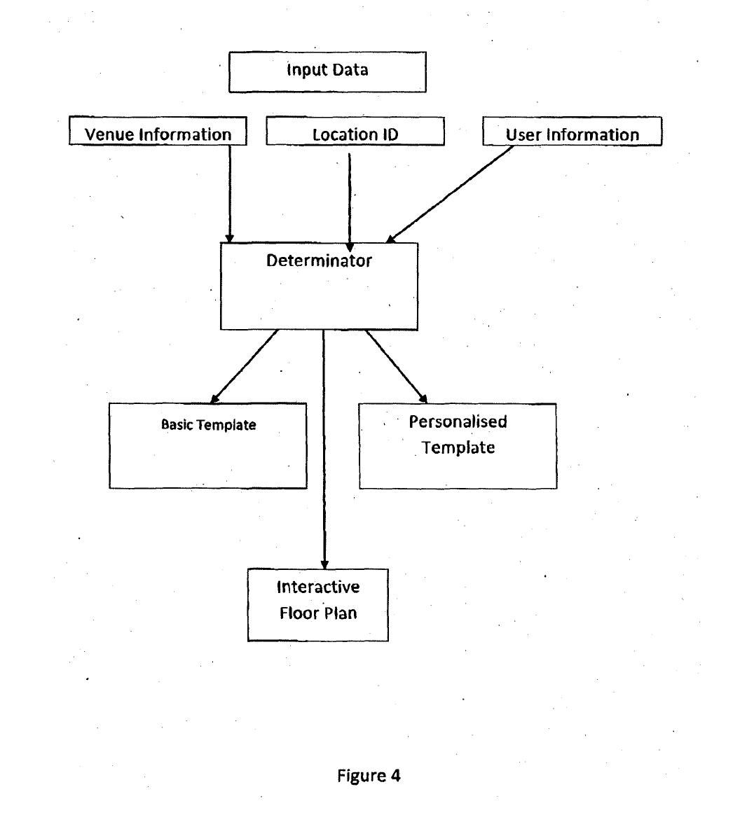

A flowchart depicting the steps taken by two users (user A and B) is shown in FIG. 3. Briefly, when creating the user profile, the system provides for predetermined fields to be completed by the user by the insertion of input data, such as user information, as shown in FIG. 4. The completed predetermined fields are then interpreted by a determinator and presented according to a template format. The template format can be basic or personalised to define a basic profile or a personalised profile. The basic format can provide a basic profile that has summary information about a user and can provide the first level of information including name and username.

The personalised template is a second level profile providing further comprehensive information in a personalised profile. The basic and personalised template can have selective disclosure such that, the user can select what input data is presented to different users and at what point, that is, before or after initiation of communication. Therefore, one or more of the fields can be kept confidential or can be selectively released to certain individuals when contact is made.

Such predetermined fields can include: first name, last name, username, and email address. Such input data can form the user's basic profile.

The predetermined fields for the personalised profile can include:
Photos and music—the communication allows the transfer of external data from the mobile communication device, hard drive or another device
Animation sound clip
Details of hobbies and interests

Such input data can form the user's personalised profile. The above fields are by example only and are modified according to the preferences of the user.

Therefore, the determinator can, from the input data provided against the predetermined fields, provide for at least different forms or levels of profile pages. In one form, the profile is a basic profile. In another form, the profile is a personalised profile allowing more customisable options. The basic profile, such as the username, can appear directly on the floor plan. Alternatively, each profile level, will have an icon accordingly located on the floor plan such that the first user can click on the icon and review the information disclosed in the basic or personalised profile. In an alternative form, a user can have both a basic and personalised profile. In doing so the determined input data of the basic profile (incorporating such information as name and username), may appear directly on the floor plan. The floor plan or the basic profile can include a further icon for the user's personalised profile allowing other users to view more comprehensive information about the other user.

As part of the user profile, a mate or female avatar icon is automatically chosen for the user based on their selected gender. Alternatively a user can select from a list of avatars, can design their own personal avatar or upload photos to be used as their representing image to their profile page. The user can further upload animations or sound clips.

In some forms, the system also enables a profile page to allow for the tracking of friends. These are a selected number of users who have access to the profile page and allow shared information. Having users as friends can allow for different coloured markings/icons to allow ready identification of whether friends are present in the venue, where they are allocated and if they are available for communication.

Passwords can be provided to the user to access their user profile and modify where required.

Different membership levels can be provided and a user can modify avatar icon based on membership level. The invention further provides for tiered membership. There can be three to five levels of membership for the users such as basic, middle and high. Membership level is determined by the number of credits i.e. higher levels require more credits. The higher levels offer more variety and rare virtual items for purchase and other advantages.

With regard to the venue, examples of predetermined fields include the venue name and address, emails and passwords. The user profile further requires the uploading and storing of details which can then be transferred to one or more mobile communication devices by the server. Such details can comprise of menus, special deals, promotional activities and a floor plan of the venue.

As the system provides for a venue, details of the venue can be set up via a website and can include such details as the venue name, address, opening hours and contact details. Similarly to the user profile, a venue profile can be set up by authorised personnel. Passwords are also provided to allow restricted use of the venue profile and only authorised changes to be made.

The invention enables a user to initiate contact via mobile communication devices with another user (“second user”) from a distance within a venue. Once contact has been established, the users can communicate via instant messaging, play online games, share/buy/trade virtual items or interact in other ways.

Once the user enters the venue, they will be prompted to enter their seat number, table number etc in the venue. This is referred to as the user's location ID. In one form, the server can automatically upload the user's location ID or can track a user's location ID as they are travelling. However, in the preferred form, the user's location ID is fixed and requires manual input.

When manually inputting, the user can recognise their location from reading the floor plan. Alternatively, the physical tables and chairs can be marked such that the user views the markings on the physical items. In a further form, the user can be handed by staff details of their location upon entry. Alternatively, an electronic connection may be available at the relevant location such that linking the mobile communication device to the electrical connection will allow for recognition of the location based ID.

To ensure that users do not incorrectly put a marker on another individuals location, location based ID can be verified by:
Wave mobile action. Such a feature allows the user's marker on the floor plan to shake when the phone is shaken. This is because the wave action provides an accelerometer recognition dictated by the server. It does not pick up walking because not sensitive enough. This allows a verification system.
Alternate forms

If a wrong location ID is entered, the user can be notified immediately.

Other options could include where the verification system is indirect:
Staff can ensure only a single location ID is provided per user and can monitor accordingly;
Allowing a single profile user to access one location ID point at a particular time and monitoring this to prevent abuse;
Recognition by the server of the number of users entering and exiting a facility to monitor the number of markers placed and markers exceeding the amount of users monitored can notify staff personnel accordingly; and,
Providing entry of details in addition to location ID such as: whether anyone is sitting next to them, behind them. Such further information will assist the server recognising false information.

If the first and second communication devices have touch screens, the user can touch their marker. In doing so, the user's avatar is displayed in addition to profile information and a list of contacts the user is currently engaging with or details of their friends.

The invention further provides for the initiation of contact and communication. In one form, the user is able to visually locate other users in the venue and, by sight, can locate them accordingly on the floor plan and determine their marker and marker colour. Alternatively, the user may wish to communicate or begin a gaming action with anyone having a green marker and thereby showing that they are available.

To initiate contact, the user touches another user's marker referred to as the target marker. A speech bubble pops 32 up next to that marker (see FIG. 5), allowing communication to occur within the speech bubble. Friend requests can be sent. The first user's avatar profile information is shown, if the first user has selected for such disclosure. Buttons to initiate contact or block/unblock a contact are further available.

The first user can cancel the bubble by selecting a cancel button, where the user would then be taken back to the floor plan.

To the second user, a notification is provided that a message is received. The location ID and username is provided of the first user (being the party that has initiated the contact). The second user has the option to accept the notification to begin communication, sending gifts or other notifications or gaming, as shown in FIG. 3. Alternatively, the second user can decline and a notification of declining is sent to the first user. The second user can modify the notification of declining to a predetermined or manually input wording from a drop down list including such examples as:
Sorry, I′m busy
Sorry, I′m not interested.

Alternatively, if the contact button is selected, the second user's mobile communication device vibrates, a speech bubble pops 32 up on the target party's device next to the sending user's marker, displaying the sending user's avatar, profile page and button to accept, decline or block from further contact.

If the second user accepts, the first user is notified accordingly. The instant messaging or chat utility starts for both parties. Both markers change colour according to profile settings (allowing multiple chats or not—if not, the markers can turn red indicating that they are no longer available), both markers glow or pulse or undergo some animation.

The communication allows for multiple simultaneous conversations. Such conversations can be on a selectable basis. This means that the user can alternate between such conversations. In doing so, the invention provides the advantage of assisting users to overcome the initial shyness in making new acquaintances. Therefore, the first communication device of a first user can be communicating with one or more second communication devices of at least one second user. The communication can be on a selectable basis.

The invention further allows the purchase of virtual items for gifting to other users. Examples of virtual items can include flowers. Accessories for the avatar such as sunglasses, bandana, scarves, jewelry, wigs etc. greeting cards, figurines, decorations, fluffy toys. Purchases can be paid with virtual credits; credits are earned by instant messaging/chatting measured by number of words transmitted. Games measure by winning prizes and participation (depending on the game). Credits can be purchased through the website via such electronic payment methods as a credit card or PayPal payment system. In an alternate form, credits can be used to purchase physical items such as drinks for third parties. Similarly, where the user purchases an item from the venue, the venue can provide credits via the website to the user.

A user can change their location ID. If the user changes location ID while currently engaged with other parties, then all engagements (such as instant messaging/chat/games) automatically diverts to the new location ID. The old location ID is released for others to use.

The invention can be further used to manage floor promotional activities and notify users of discounts, raffles etc.

Users can communicate, with the view of participating in a game within or external to the system. A game provided by the system can include Tic Tao Toe, Papers Scissors Rock and Memory Game.

A summary of the operation of a communication system in accordance with an embodiment of the invention is as follows:
i. Participating venues setup their profiles & upload their floor plans onto the Server;
ii. Users setup their profiles (this can also be done after steps (iii) and (iv);
iii. When a user arrives at a participating venue, they connect their mobile device to the venue's Wi-Fi;
iv. The venues' floor plan is retrieved, whether automatically or by request;
v. On the floor plan, markers display the location of all users in the venue. (this is illustrated in FIGS. 5 and 6);
vi. The user is prompted for their location ID. This can be, for example, their seat number or table number:
vii. On receipt of the location ID, a marker is displayed on the floor plan identifying the users location;
viii. When a user wants to contact a second user, the corresponding marker on the floor plan indicating the location of the second user is activated and the second user receives a request on their mobile communication device;
ix. The second user accepts the request and both users can communicate. This communication can be, for example, via instant messaging or interact via games;
x. The venue can communicate via the Server with connected users to make announcements, promotions, discounts, raffles and the like.

However, it is recognised that a further embodiment of the invention can operate as follows:
Connecting to the server and receiving a floor plan;
Visually locating/sighting another user;
Using the floor plan to record or locate the location ID of the second user or other user; and,
Sending a notification to the second user. If the second user accepts the notification, a speech bubble appears and communication begins.

This alternate embodiment allows a ‘personalised’ floor plan, whereby the marking of other users occurs where the other second users are in direct or current communication with the first user.

Therefore the step of sighting can:
Occur prior to a marking being made, and/or,
Following the placement of the markers on the floor plan.

The invention may further be improved to recognise the presence of individuals that do not form a connection in order to accurately display the number of occupants and tables/chairs occupied. This may be for example through signals sent where the chairs are provided with sensors.

In use, invention allows the first communication device to be recognised by the primary communication device in the venue where the primary communication device is capable of receiving and transferring details of the venue and the first communication device is capable of receiving the details of the venue. In use, details of the venue are transferred from the primary communication device to the first communication device, and displaying the details of the venue on the first communication device and location based information of one or more second communication devices being communication devices of other users.

The first communication device can be in a visually locatable position to a second communication device.

The above features of the system and process for communication can be described more particularly as follows:

### 1: Signup/Login

A user wilt have two options for login that is, to either create an account, or extract information from external sources, e.g.: by connecting to Facebook and extracting appropriate information to create an account. Input data to create an account can include email address, password, full name, gender and date of birth.

### 2. Profile Setup

A user can create a profile. Some fields will be auto-filled based on the input data the user provided upon signup. The user can modify information provided during signup including password and name changes. The profile, depending on whether it is a basic profile or personalised profile, will include:
A profile picture. This can be uploaded from the device, or an avatar can be selected based on a group of pre-defined standard avatars.
A background image. This image will display when another user looks at the user's personalised profile. It can be uploaded from the mobile communication system.
Interests/expertise/favourite food. This is a text input that allows the user to list various interests and their expertise.
Maintaining virtual gifts received from other users.

### 3. Check-In

In order to access many of the features of the system, the user must check-in to a specific seat within a venue. A unique seat code will be generated on the server and provided to a user by venue staff. This code will be inputted by the user and other secondary users via a floor map of the venue.

### 4. Floor Plan

After check-in a user can view a floor plan of surrounding users. This floor plan is uploaded by the venue through the administration content management system (“CMS”) and is tagged with seat locations enabling accuracy of location within the venue (non GPS) down to the seat level. The floor plan allows a user to click on other user's markers and view their public profile. The floor plan also allows for a user to check-out of a venue/seat, and view some basic statistics about themselves including Current credits, total check-ins, username, profile picture

User markers will be coloured differently depending on whether they have a basic profile or a personalised profile or if they are currently busy (engaged in conversation or games with other users). Further icons can be provided to allow access to the basic and/or personalised profile. Busy users can still be contacted. If a user shakes their phone rapidly their icon on the map will jump.

### 5: Public Profile

A user's public profile contains input data identifying them to other users. It includes Username, gender, date of birth, interests/expertise, favourite food, virtual gifts received, profile picture, custom background image.

Accessing a second user's profile page allows an invitation to be sent to that second user to play a communal game. A dialogue box appears on the user's profile to allow selection from a list of bundled mini-games. Upon selecting a game an invitation is sent to the second user, and, if accepted the first user is notified and can begin playing the game.

The profile page further allows the ability for the first user to communicate with the second user via a chat interface. The profile page further allows a first user viewing the profile of a second user to send a gift to the second user. This includes virtual gifts that can be purchased using credits via a virtual gift store, or a real world gift from a pre-populated list of real gift invitations.

### 6. Real World Gifts

A user can select to send another user a real world gift (RWG) via invitation. RWGs are uploaded by an administrator using the web CMS and can be chosen from a list by the user. Upon selecting a RWG the user is presented with a text field to enter a descriptive message to send to the other user upon them accepting the gift. This message is designed to provide the other user with instructions on how to proceed, and is only shown after they have expressed they would like to accept the user's invitation.

### 7. Chat Room

A user can maintain several ‘one to one’ text conversations via the chat room. In one embodiment, there is a group chat function. Through the chat interface users can also send files in the following formats that are stored on the device audio (mp3, way), video (.mov), photo (.jpg). Each message sent/received contains a profile picture, a time stamp and the message. Every time a new message is received, a counter is iterated on the particular conversation indicator. There is also advertising space allocated on the chat window.

### 8. Game: Tic Tac Toe

A user can challenge another user to a game such as tic tac toe. They can maintain several ‘one on one’ games with different users. This game is turn based. The user taps in the space they wish to play their move, and this is sent to the other user to record their counter move. Once a move is received, the user will be notified and the game board updated. The game is completed either when a user connects three spaces vertically, horizontally or diagonally in a line, or if it is deemed impossible for a user to do so. In the latter case the game is tied, and the user is asked to play again. The user also has the ability to view game history statistics, which are displayed in a popup view and include the user's top 5 longest winning streaks.

### 9. Game: Rock, Paper, Scissors

A user can challenge another user to a game of rock, paper, scissors. They can maintain several one on one games with different users. This game is turn based. The user taps the hand shape they wish to play, and the other user is notified. Once both users have selected their hand shape the game plays out and shows both users the winner. The user also has the ability to view game history stats, which are displayed in a popup view and include the user's top 5 longest winning streaks.

### 10. Game: Memory

A user can challenge another user to a game of memory. They can maintain several one on one games with different users. This game is turn based. A user selects two sequential cards from the grid by tapping on the card icons and the cards are flipped over. The aim is to find two cards that match. Each time a match is found the user is given a point, and the cards are removed from the grid. A successful match grants the user an extra turn. Upon an unsuccessful attempt at matching, the users turn is ended and the other user is notified they can begin. When all pairs are unveiled the game ends and points are tallied. The winner is the user with the most points.

The user also has the ability to view game history stats, which are displayed in a popup view and include the user's top 5 longest winning streaks. Two of the card pairs in the game will be the player's avatars.

### 11. Menu/Specials

A user has the ability to look at the menu/specials for the venue they are currently checked into. The items on this list are populated by the venue via the web CMS. Items are separated out into venue defined categories. Each item contains the following information an image (optional), an item name, a short description and a price.

### 12. Virtual Gift Store

A user can select from a list of virtual gifts to send to another user. The list of gifts is populated by the CMS. Some gifts will be free to the user, and others will require them to spend credits. Each gift within the store will display the following information: an image, a price (in credits), an item name and a short description

### 13. Coupon List

A user can view both the coupons available at the current venue and all coupons available globally. Each venue populates their own coupon list via the web CMS. A user can search for coupons using a search box under the list of coupons. Upon clicking on a coupon the user can commence the process of redemption. Each coupon will display the following information: an image, an item name and a short description

### 14. Coupon Page

A user can view extended information about a coupon, including: a feature image, an item name and a short or long description of the coupon. Coupons can be redeemed using the on-screen redeem button,

### 15. Coupon Redemption

Upon redeeming a coupon a user is presented with the redemption screen. This screen contains: the coupon's feature image, a unique redeem code and a security countdown timer to prevent multiple redemptions. The redeem code is an optional protection measure, and is entered by a venue admin via the web CMS.

The operation of the Administrative CMS can be as follows:

### A. Login

Before access is granted to the CMS the CMS must first log in. There are two types of user accounts: Application administration (AA) and Venue administration (VA) AA's are responsible for maintaining application wide data, whereas VA's have control of only the content relevant to their own venue.

### B. Management of Users by VA

A VA can manage any users currently checked in to their venue. Management options include: send user a notification, give user a random prize (by means of a custom message), block user (AA blocks from app, VA blocks from venue), list all users in a particular venue, and give a checked-in user a nominal amount of credits (non active at launch)

### C. My Venue (VA)

After logging in the VA is presented with a dashboard with the same stats as the AA Dashboard, except the stats are limited to their particular venue. They also have the ability to manage venue content including: edit venue information, upload/edit seat map, and add/edit menu items/specials.

### D. Edit my Venue (VA)

A VA can manage their venue information at any time and have the adjustments pushed through to the client mobile application. They can manage the following information:
Admin email
Admin password

View only: venue name, address, city, country, state and zip Code. When changing password the new password must be entered twice to ensure no errors in typing occurred.

### E. Edit Floor Plan (VA)

A VA can manage their floor plan and seat allocations via an interactive interface, allowing them to choose a table and seat number before clicking on the seat location on an uploaded floor plan image to tag the seat location. Each seat location directly corresponds to the positions within the venue a user can check in to.

At any stage a VA can upload a new map image for the venue if the layout changes. Uploading a new map image deletes all old tagged seat locations. There is validation in place to ensure only images of a correct format and size are uploaded. Supported formats and sizes are:
PNG/JPG 1 mb or smaller

The interface also provides sample images of floor plans that are formatted to show VAs the ideal size and level of detail.

Once seats are tagged, the VA can print a list of seat codes to be given to users wishing to check in to a seat. These codes are automatically regenerated each 24 hours and an email is sent to the registered admin email address with a list of the latest codes. Alternatively this process can be done manually from the interface should the VA opt to do so. If codes are regenerated when a user is checked in with an old seat code, the user remains checked in until they check out.

### F. Menu and Specials (VA)

A VA can manage the menu items and specials that are presented to users. They can view a list of items, edit or remove those items and add new ones. Upon adding a new item, the VA must enter the following information: item name, price, item subtitle, category and short description.

### G. Coupons

A VA can view a list of coupons their venue is currently offering. They can edit, or remove any of these coupons as well as generate new ones. Adding or editing a coupon brings up a specific coupon input screen with the following required inputs: coupon title, price, subtitle, description, image, and expiry date.

### H. Real World Invitations NA)

A VA can manage a list of real world invitations, and view the number of times a user has used each item. They can also edit/add new items through a form with the following inputs: invitation name (the task the user will ask another user to participate in), full invitation text, and, an image representing the task

### I. Statistics (VA)

A VA can view in depth statistics about usage of the communication application at their venue, including: user activity, user demographics, activity periods, check ins and top gifts. The details within each of these categories is defined in the graphic mockups for the stats page.

### J. Dashboard (AA)

After logging in the AA is presented with a dashboard showing check-in stats and some general stats, including: total check-ins (this may related to a specific venue or be an overview of all venues in which the communication system is employed), in the last 24 hours, last 7 days, live or total users, total venues, gifts bought.

### K. Venues (AA)

An AA can manage registered venues. They can view a list of venues, edit or remove a venue and add new venues. Upon adding/editing a venue the AA must supply the following information: venue name, address, city, country, state, zip code, VA email, and VA password. Any changes the AA makes to a VA account take precedence over VA initiated changes. An AA can also suspend/re-activate a venue at any stage. Suspending a venue will disable check-ins at that venue, block the VA login details and stop seat codes from being re-generated and automatically emailed to the VA.

### L. Edit Seat Map (AA)

An AA can manage any venue's seat map. All functionality quoted in the VA seat functionality applies except an M's changes take precedence over VA initiated changes.

### M. Manage Users (AA)

An AA Can do all the functions of the VA in the corresponding section, with the additional ability to see extended information about a user, including: current credits, gender, age, favourite venue, avatar, total check-ins, number of venues visited, gifts purchased and a list of previous credit spends with date and time, points earned and the venue spent at.

### N. Gift Store (AA)

Virtual gifts can be purchased by users using credits. The items that appear in the virtual gift store are managed by an AA. The AA is presented with a list of current gifts, and can remove, edit or add a new gift. Adding or editing an existing gift displays the gift details screen where the M can provide the following information: item name, price (credits), subtitle, description and image.

### O. Avatar Store (AA)

Avatars can be purchased by users using credits. The items that appear in the avatar store are managed by an AA. The AA is presented with a list of current avatars, and can remove, edit or add a new one. Adding or editing an existing avatar displays the avatar details screen where the AA can provide the following information: item name, price (credits), subtitle, description and image.

### P. Real World Invitations (AA)

While a VA has control over a list of real world invitations (RWIs) specific to their venue, the AA can control a list of global RWIs that are pushed to all apps. The functionality of adding/editing and removing RWIs in the AA interface is identical to the outlined functionality of the VA.

### Q. Statistics (AA)

An AA can view app-wide statistics in much the same way as a VA can with venue specific stats. The exact functionality of the stats engine is outlined in the graphic mock ups for this screen.

### R. Public Website

### 1. Promotional Home Page

A prospective user or venue can view a web page containing images and copy promoting the invention application,

2. User registration system and profile management

A user has the option of creating their account and profile either from the mobile app, or from the public website.

### 3. Forum

A third party open source forum solution will be implemented to allow discussion around the invention application.

### S. Miscellaneous Features

1. Tiered level system.

Users are ranked based on the amount of credit they have earned and allows them to unlock extra virtual gifts. These gifts will be present on the virtual gift store, but pictured with a lock over them until the user levels up far enough to unlock them.

### 2. Animated Notifications

Whenever a user receives a notification from the app, venue, or another user they are alerted with an animated popup. Animation is created using standardized platform translations including rotation, scaling and opacity, and can include sound effects.

### 3. Credit System

A user can earn credits for their interactions with the app. For instance, a user might earn 5 credits for every game they complete or 2 credits when they send a chat message. These values will not be adjustable by the admin and will be entered directly into the database.

While we have described herein a particular embodiment of a system and process for communication, it is further envisaged that other embodiments of the invention could exhibit any number and combination of any one of the features previously described. The described embodiments are considered in all respects only as illustrative and not restrictive. However, it is to be understood that any variations and modifications can be made without departing from the spirit and scope thereof.

1. A system for communication between users at a venue, the system comprising:
a. detecting a first communication device of a first user recognisable by a primary communication device in a venue, the primary communication device capable of transferring details of the venue, the first communication device being capable of receiving details of the venue;
b. transferring the details of the venue from the primary communication device to the first communication device; and
c. displaying the details of the venue on the first communication device and location based information of one or more second communication devices being communication devices of other users.

2. A system according to claim 1 wherein profile information from the primary communication device is also transferred to the first communication device.

3. A system according to claim 1 or 2 wherein the first communication device and second communication device are mobile phones.

4. A system according to claim 1, 2 or 3 wherein the primary communication device allows the first communication device to communicate with one or more of the second communication devices.

5. A system according to any of the preceding claims wherein the primary communication device is a server.

6. A system according to any one of the preceding claims, wherein the primary communication device is accessed by a first user having a first mobile communication device within the venue.

7. A system according to any one of the preceding claims, wherein the primary communication device is accessed by the first mobile communication device outside the venue zone.

8. A system according to any one of the preceding claims wherein the communication system can be downloaded by the user inside or outside the venue.

9. A system according to any one of the preceding claims, wherein the details of the venue comprise a floor plan of the venue.

10. A system according to any one of the preceding claims wherein the location based information is a user's location to identify the users position on a floor plan of the venue.

11. A system according to claim 10 wherein the user's location ID is displayed as a marker on the floor plan, allowing other users to view on the floor plan the position of the marker of a number of users.

12. A system according to claim 10 wherein the location based information is allocated to the user.

13. A system according to claim 10 wherein the location based information is entered by the user.

14. A system according to claim 10 wherein the location based information is detected about the user.

15. A system according to claim 10 wherein the location based information is dynamically altered in real time.

16. A system according to claim 10 wherein the location based information is checked directly by comparison of the location based information of a user's first communication device and actual location.

17. A system according to any one of the preceding claims wherein the user of claim 1 can create a user profile.

18. A system according to claim 17, wherein the user profile is a basic profile comprises first level of information comprising the user's name and username.

19. A system according to claim 17, wherein the user profile is a personalised profile comprising comprehensive information about the user.

20. A system according to claim 17 wherein a determinator automatically determines one or more profiles by input data entered by the user.

21. A system according to claim 17 wherein the user pre-selects what input data is presented on the profile page.

22. A system according to any one of the preceding claims, wherein the first communication device is in a visually locatable position to the one or more second communication devices and both the first communication device and at least one or more second communication devices are included in the details of the venue.

23. A system for communicating between users at a venue, the system comprising:
a first communication device recognisable by a primary communication device in a venue, the primary communication device capable of receiving and transferring the floor plan of the venue;
wherein, the primary communication device transfers to the first communication device a location system, which the floor plan indicates the position of the first communication device and a second communication device;
wherein the first communication device is in a visually locatable position to a second communication device.

24. A system according to claim 23 wherein the primary communication device is a server.

25. A system according to claim 23 wherein the primary communication device is a combination of a server and a router.

26. A system according to claim 23 wherein the pre-defined location system is selected from one or more of a mapping system, coding system and/or locating system.

27. A process for communication, comprising the steps of:
b. connecting a first mobile communication device of a first user to a server;
a. transferring a floor plan of a venue from the server to the first mobile communication device;
b. marking a location of the first communication device on the floor plan; and
c. marking the location of a second communication device on the floor plan wherein, the first user can view the location of a second user of the second communication device to initiate communication

28. A process according to claim 27, wherein the server is located within the venue.

29. A process according to claim 27 providing a product resulting from the above one or more processes.

30. A process for communication according to claim 27 wherein the product comprises an interactive floor plan having:
a. a display of one or more rooms and the furnishings of such rooms;
b. at least two markers defining a first user's and a second user's location on the floor plan relative to the rooms and the furnishings;
c. the marking operatively defining a communication means between the first user and a second user.

31. A system of communication comprising:
a. Providing an operational marker on a virtual floor plan to identify the location of a user;
b. determining the position of the user on a floor plan by viewing the marker on the floor plan;
c. initiating contact by sending a request to the user by activating the operational marker to provide a means for communication;
wherein the user is able to accept or decline the request and a notification can be sent accordingly.

32. A system of communication according to claim 31 wherein if declining the request, the notification includes a personalised message.
